(19) United States
(12) Patent Application Publication
(10) Pub. No.: US 2026/0100931 A1
(43) Pub. Date: Apr. 9, 2026

(54) SECURE ACCESS SERVICE EDGE STATIC INTERNET PROTOCOL POOL MANAGEMENT PORTAL

(71) Applicant: T-Mobile Innovations LLC, Overland Park, KS (US)

(72) Inventors: Anis Adil ANIS, Bay Point, CA (US); Brent Matthew Johnston, Ardmore, AL (US); Cristian Asandului, Snoqualmie, WA (US); Nathan Paul Wilhoft, Shawnee, KS (US); Nancy Lynne Atkinson, Raymore, MO (US); Kenneth S. Walker, Olathe, KS (US); Richard Gene Ross, Kingsville, MO (US)

(21) Appl. No.: 18/908,393

(22) Filed: Oct. 7, 2024

(51) Int. Cl. H04L 61/5007; H04L 61/5061

(52) U.S. Cl. CPC H04L 61/5007; H04L 61/5061

(57) ABSTRACT

The technology disclosed herein relates to systems, methods, and computer storage media for providing a secure access service edge (SASE) static internet protocol (IP) pool management portal (the “management portal”). The management portal enables a user to submit a request for a static IP address. Upon submitting the request, the management portal enables the user to visualize available IP segments. Moreover, the management portal selects an IP segment of the IP segments. In some aspects, the management portal provides confirmation comprising details of the IP segment and secure connection to the user. Additionally, the management portal may enable the user to monitor IP usage and connectivity status. Both users and administrations may manage assignments, resolve conflicts, and/or release the IP segment via the management portal.

### SUMMARY

In aspects set forth herein, and at a high level, the technology described herein relates to systems, methods, and computer storage media for providing a secure access service edge (SASE) static internet protocol (IP) pool management portal (the “management portal”). The management portal enables a user to submit a request for a static IP address. Upon submitting the request, the management portal enables the user to visualize available IP segments. Moreover, the management portal enables the user to select an IP segment of the IP segments. In some aspects, the management portal provides confirmation comprising details of the IP segment and secure connection to the user. Additionally, the management portal may enable the user to monitor IP usage and connectivity status. Both users and administrations may manage assignments, resolve conflicts, and/or release the IP segment via the management portal.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present technology are described in detail herein with reference to the attached figures, which are intended to be exemplary and non-limiting, wherein:

FIG. 1 illustrates a diagram of an exemplary communication environment in which implementations of the present disclosure may be employed;

FIG. 2 illustrates a diagram of an example of a Fifth Generation (5G) communication network for providing a Secure Access Service Edge (SASE) static IP pool management portal, in accordance with aspects herein;

FIG. 3 is a flow diagram of an example method for providing a SASE static IP pool management portal, in accordance with some aspects of the technology described herein; and

FIG. 4 depicts an example computing environment suitable for use in implementation of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:

3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022).

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast arc for communication with mobile handsets linked to the base station.

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service.

The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network.

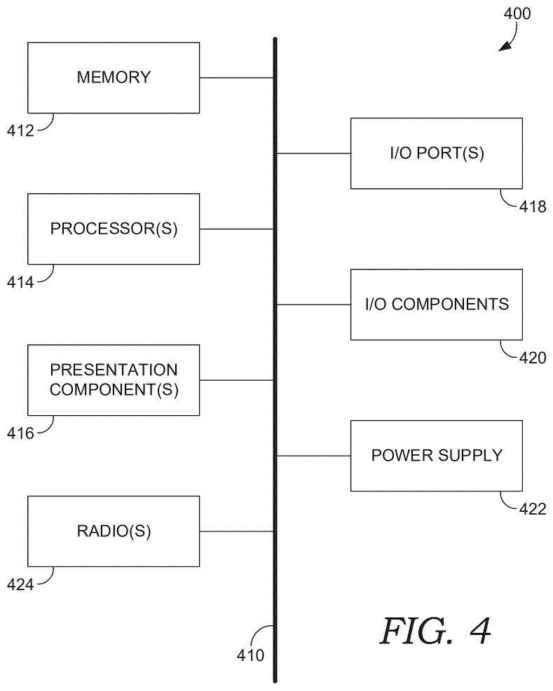

For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point. A UE may be, in an embodiment, similar to device 400 described herein with respect to FIG. 4.

By way of background, wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Edge based security services provide security controls at a point of access instead of routing traffic to a data center where security policies are enforced. Points of access may include a user device, an Internet-of-Things (IoT) device, an access network, an edge computing location, and the like. Secure Access Service Edge (SASE) is a type of edge-based security service. SASE ensures real-time, context aware policy enforcement to secure user and device traffic. SASE comprises a flexible zero trust architecture that enforces security policies on data sessions between user devices and enterprise networks and/or the public internet. SASE encompasses a range of security solutions, including Zero Trust Network Access (ZTNA), Secure Web Gateways (SWG), Cloud Access Security Brokers (CASB), Firewall as a Service (FWaaS), and the like. This integrated approach allows SASE to provide secure and optimized connectivity to cloud services, applications, and resources from any location or device. SASE routes traffic to user devices based on the device's Internet Protocol (IP) address.

Wireless communication networks assign IP addresses to user devices during a process referred to as registration. Each time a device attaches to the network, the device registers with the network for wireless service. The network assigns the device an IP address in response to the registration. The network uses the IP address to route data to the device. When the device detaches from the network, the network deregisters the device for service and the IP address for the device is removed. Consequently, device IP addresses change over time. The dynamically changing IP addresses of user devices makes it difficult for edge-based security services like SASE to route traffic to devices over wireless communication networks. Moreover, assigning static IP addresses manually can lead to inefficiencies, potential conflicts, and security risks.

The present disclosure is directed to systems, methods, and computer readable media that systems and methods for providing a SASE static IP pool management portal. The IP pool management portal provides an innovative management portal solution that automates the assignment of static IP addresses, integrates secure connectivity, and efficiently manages IP pool segmentation. By leveraging automation and integration, mobile service providers can enhance user experience, improve security, and streamline the IP management processes.

In aspects, the management portal provides an automated system for assigning static IP addresses from a predefined pool, minimizing the time and resources needed for managing IP assignments. The management portal is also scalable and capable of accommodating an expanding user base and a growing number of IP segments. The management portal uses a hierarchical IP pool segmentation (e.g., breaking a /8 pool into multiple /12 to /24 segments depending on the customer need) and ensures each user gets a unique segment to avoid IP conflicts. Additionally, the management portal can be integrated with SASE vendors to provide a secure connectivity solution and ensure secure data transmission for users assigned static IPs.

In some aspects, the management portal enables internal and external users to manage IP assignments and connectivity. The management portal also provides a visual representation of IP pool segments and their current utilization, offering clear visibility into the allocation of IPs. Tools for reserving and assigning IP segments and mechanisms to prevent double assignments and IP conflicts are provided by the management portal. When users disconnect, automated processes free up the respective IP segments. In aspects, the management portal is connected with internal provisioning and confirmation tools to ensure coordination between different systems and to provide real-time updates and statuses.

In a first aspect of the present invention, computer-readable media is provided, the computer-readable media having computer-executable instructions embodied thereon that, when executed, perform a method of providing a SASE static IP pool management portal. The method comprises receiving, via a management portal, a request from a user for a static internet protocol (IP) address. The method also comprises providing, via the management portal, available IP segments. The method further comprises selecting, by the management portal, an IP segment of the IP segments. The method also comprises integrating the IP segment, via the management portal, with a SASE vendor to set up secure connectivity for the user.

A second aspect of the present disclosure is directed to a method of providing a SASE static IP pool management portal. The method comprises receiving, via a management portal, a request from a user for a static internet protocol (IP) address. The method also comprises providing, via the management portal, available IP segments. The method further comprises selecting, by the management portal, an IP segment of the IP segments. The method also comprises integrating the IP segment, via the management portal, with a SASE vendor to set up secure connectivity for the user.

Another aspect of the present disclosure is directed to a system for providing a SASE static IP pool management portal. The system comprises: a node configured to wirelessly communicate with user equipment (UE); and the UE configured to: enable a user to submit, via a management portal, a request for a static IP address; enable the user to visualize, via the management portal, available IP segments; and select, by the management portal, an IP segment of the IP segments.

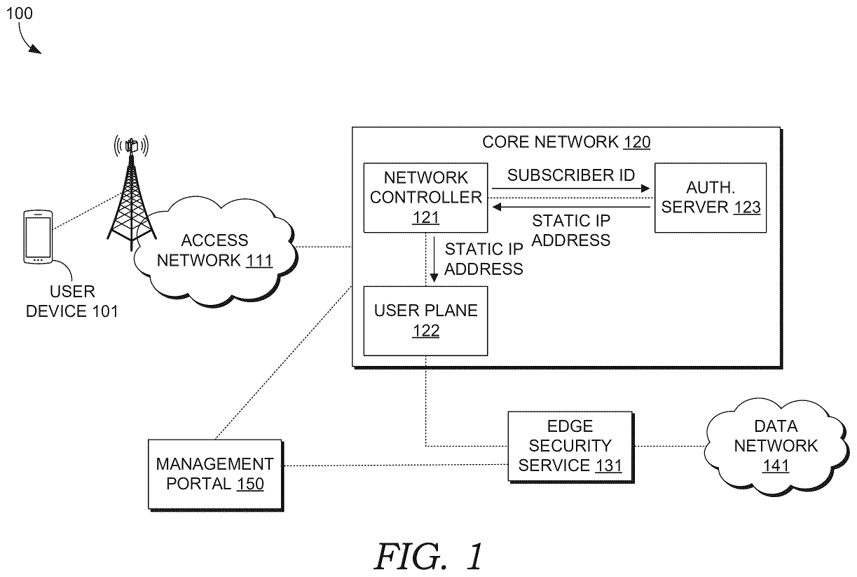

FIG. 1 illustrates a diagram of an exemplary communication environment 100 in which implementations of the present disclosure may be employed. Communication network 100 provides services like media-streaming, internet-access, voice/video calling, text messaging, machine communications, or some other wireless communications product. Communication network 100 comprises user device 101, access network 111, core network 120, edge security service 131, data network 141, and management portal 150. Core network 120 comprises network controller 121, user plane 122, and authentication server 123. In other examples, communication network 100 may comprise additional or different elements than those illustrated in FIG. 1.

Various examples of network operation and configuration are described herein. In some examples, user device 101 attaches to core network 120 over access network 111. Device 101 transfers a registration request to network controller 121 over access network 111 to register for service on communication network 100. The registration request includes a subscriber Identifier (ID). Exemplary subscriber IDs include Subscriber Concealed Identifier (SUCI), Subscriber Permanent Identifier (SUPI), International Mobile Subscriber Identifier (IMSI), Fifth Generation Global Unique Temporary Identifier (5G-GUTI), and the like. Network controller 121 receives the registration request and authenticates the subscriber ID indicated by device 101. Additionally, the registration request comprises a request for a static IP address. Responsive to authentication, network controller 121 authorizes device 101 for service on network 100 and detects if user device is subscribed for static IP address assignment and edge-based security service. In response, network controller 121 forwards the subscriber ID to authentication server 123. Authentication server 123 performs a secondary authentication of user device 101. Management portal 150 provides available IP segments to the user. For clarity, the IP segments are from a /8 pool and may be dynamically divided from the /8 pool into /12 or /24 subnets. In some aspects, the management portal 150 selects an IP segment. The selected IP segment may be assigned to the user. Authentication server 123 maps the subscriber ID for device 101 to the static IP segment and indicates the static IP address to network controller 121. Static IP assignments are IP addresses that are reserved for a specific device and do not change. This contrasts with dynamic IP addresses, which are assigned to devices on a temporary basis and can change over time. Static IP assignments can be useful for a variety of purposes, including remote device management, hosting servers, and running certain applications. Network controller 121 assigns the static IP address to device 101 to use for data sessions on network 100. Management portal 150 provides confirmation comprising details of the IP segment and secure connection to the user. Management portal 150 may further provide tools for monitoring IP usage and connectivity status and/or enable users and administrations to manage assignments, resolve conflict, and/or release the IP segment.

Network controller 121 indicates the static IP address to device 101 and to user plane 122. User plane 122 forwards the IP address and subscriber ID for device 101 to edge-based service 131 (e.g., SASE vendor). In aspects, the management portal 150 integrates the selected IP segment with the edge-based service 131 to set up secure connectivity for the user. User device begins a data session on network 100. User device 101 exchanges user data for the session with user plane 122 over access network 111. User plane 122 exchanges the user data with edge security service 131. Edge security service 131 enforces security polices (e.g., malware detection) on the session and exchanges the data with data network 141. For example, security service 131 may perform content filtering, session security, malware scanning, contents filtering, Domain Name System (DNS) filtering, firewall, intrusion detection and the like. Security service 131 exchanges the user data with data network 141. Data network 141, edge security service 131, and user plane 122 route data to device 101 over network 100 based on the static IP address.

Advantageously, wireless communication network 100 effectively and efficiently selects and allocates static IP addresses to user devices to facilitate communication between the user devices and the edge security services. Moreover, by utilizing static IP address assignments, wireless communication network 100 increases network 100 and edge security service's ability to support remote device management, hosting servers, and running certain applications.

User device 101 comprises a vehicle, drone, robot, computer, phone, sensor, or another type of data appliance with wireless and/or wireline communication circuitry. User device 101 and access network 111 communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WIFI), Low-Power Wide Area Network (LP-WAN), Bluetooth, and/or some other type of wireless networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access network 111 is illustrated as a tower, network 111 may comprise another type of mounting structure (e.g., a building), or no mounting structure at all. Access network 111 comprises a Sixth Generation (6G) Radio Access Network (RAN), Fifth Generation (5G) RAN, LTE RAN, gNodeB, eNodeB, NB-IoT access node, trusted non-3GPP access node, untrusted non-3GPP access node, LP-WAN base station, wireless relay, WIFI hotspot, Bluetooth access node, and/or another wireless or wireline network transceiver. Access network 111 exchanges network signaling and user data with network controller 121 and user plane 122 clustered together into core network 120. Access network 111 is connected to network core 120 over backhaul data links. Access network 111 and core network 120 may communicate via edge networks like internet backbone providers, edge computing systems, or another type of edge system to provide the backhaul data links between node 111 and core network 120.

Access network 111 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120. Access network 111 may comprise Baseband Units (BBUs). The BBUs handle lower and higher network layers like RRC, PDCP, RLC, MAC, and PHY. The BBUs are coupled to network entities in core 120.

Core network 120 is representative of computing systems that provide wireless data services to user device 101 over access network 111. Exemplary computing systems comprise Network Function Virtualization Infrastructure (NFVI) systems, data centers, server farms, cloud computing networks, hybrid cloud networks, and the like. Core network 120 may comprise a Third Generation Partnership Project (3GPP) core network architecture like Sixth Generation Core (6GC), Fifth Generation Core (5GC), Evolved Packet Core (EPC), and/or another type of 3GPP core network architecture. Access network 111, core network 120, edge security service 131, data network 141, and management portal 150 communicate over various links that use metallic links, glass fibers, radio channels, or some other communication media. The links use 6GC, 5GC, EPC, IEEE 802.3 (ENET), Time Division Multiplex (TDM), Data Over Cable System Interface Specification (DOCSIS), Internet Protocol (IP), General Packet Radio Service Transfer Protocol (GTP), 6GR, 5GNR, LTE, WIFI, virtual switching, inter-processor communication, bus interfaces, and/or some other data communication protocols. The computing systems of core network 120 store and execute the network functions/entities to form network controller 121, user plane 122, and authentication server 123. Network controller 121 may comprise network functions/entities like Access and Mobility Management Function (AMF), Session Management Function (SMF), Authentication Server Function (AUSF), Unified Data Management (UDM), Mobility Management Entity (MME), and Home Subscriber Server (HSS). User plane 122 comprises network functions/entities like User Plane Function (UPF), Serving Gateway (S-GW), Packet Gateway (P-GW). Authentication server 123 comprises network functions/entities like Authentication, Authorization, and Accounting (AAA) server and the like. In some aspects, although shown as a separate entity, features of the management portal 150 may be provided by components of core network 120.

Edge security service 131 comprises a cloud-based computing system that applies security policies on sessions between core network 120 and data network 141. Security service 131 may comprise a Secure Access Service Edge (SASE). In other examples, security service 131 may provide another type of edge-based service (e.g., content distribution). Data network 141 comprises an Application Server (AS) that hosts applications (e.g., media streaming applications, messaging SMS applications, etc.) for device 101.

User device 101 and access network 111 comprise antennas, amplifiers, filters, modulation, analog/digital interfaces, microprocessors, software, memories, transceivers, bus circuitry, and the like. User device 101, access network 111, core network 120, edge security service 131, and data network 141 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 100 as described herein.

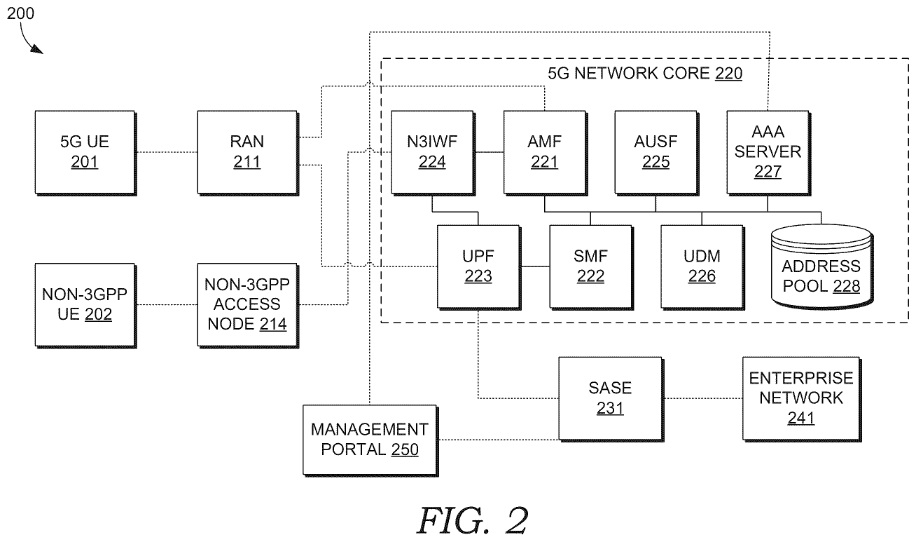

FIG. 2 illustrates an example of a Fifth Generation (5G) communication network for providing a Secure Access Service Edge (SASE) static IP pool management portal. 5G communication network 200 comprises an example of communication network 100 illustrated in FIG. 1, however network 100 may differ. 5G communication network 200 comprises 5G User Equipment (UE) 201, non-Third Generation Partnership Project (3GPP) UE 402, 5G RAN 211, non-3GPP access node 212, 5G network core 220, SASE 231, enterprise network 241, and management portal 250. 5G network core 220 comprises AMF 221, SMF 222, UPF 223, non-3GPP Interworking Function (N3IWF) 224, AUSF 225, UDM 226, AAA server 227, and address pool 228. Although shown as a separate entity, in some aspects, features of the management portal 250 may be provided by one or more components of the 5G network core 220. Other network functions and network entities like Network Slice Selection Function (NSSF), Policy Control Function (PCF), Unified Data Registry (UDR), Home Subscriber Register (HLR), Network Repository Function (NRF), Short Message Service Function (SMSF), Network Exposure Function (NEF), Application Function (AF), Equipment Identity Register (EIR), and Session Communication Proxy (SCP) are typically present in 5G network core 220 but are omitted for clarity. In other examples, 5G communication network 200 may comprise different or additional elements than those illustrated in FIG. 2.

In some examples, UE 201 wirelessly attaches to 5G RAN 211 over a 5GNR link. UE 201 is a wireless user device associated with enterprise network 241. UE 201 undergoes a RACH procedure with 5G RAN 211 to establish a secure signaling channel. UE 201 transfers a registration request to AMF 221 over 5G RAN 211. The registration request indicates a registration type, 5G-GUTI, TAI, NSSAI requests, UE capabilities, requests for PDU sessions with enterprise network 241, a request for a static IP segment, and the like. In response to the registration request, AMF 221 transfers a NAS identity request to UE 201 over a NAS signaling link between UE 201 and AMF 221 that traverses RAN 211. UE 201 indicates its SUCI to AMF 221 over the NAS link that traverses 5G RAN 211. AMF 221 transfers an authentication request to AUSF 225 to retrieve authentication vectors to authenticate UE 201. The request comprises the SUCI for UE 201. AUSF 225 indicates the SUCI and requests authentication vectors from UDM 226. UDM 226 accesses the subscriber profile for UE 201 and derives the SUPI for UE 201 based on the SUCI. The SUPI comprises the IMSI associated with the Subscriber Identity Module (SIM) card for UE 201. UDM 226 generates authentication vectors for UE 201. UDM 226 returns the vectors and SUPI to AUSF 225. The authentication vectors comprise a random number, expected result, key selection criteria, and the like. AUSF 225 forwards the SUPI and authentication vectors to AMF 221. AMF 221 transfers an authentication challenge that comprises the random number and key selection criteria to UE 201 over the NAS link that traverses RAN 211. UE 201 hashes random number with its secret key to generate an authentication result and indicates the authentication result to AMF 221 over the NAS link. AMF 221 matches the expected result retrieved from AUSF 225 with the authentication result received from UE 201 to authenticate UE 201.

Responsive to the authentication, AMF 221 transfers a context registration request to UDM 226 that includes AMF ID, a supported feature list, a Permanent Equipment Identifier (PEI) for UE 201, and the like. UDM 226 indicates successful UDM registration to AMF 221. In response, AMF 221 requests access and mobility subscription data, SMS selection subscription data, and UE context in SMF data from UDM 226. UDM 226 accesses the subscriber profile for UE 201 and returns the requested data. The access and mobility subscription data comprises a supported feature list for UE 201 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of S-NSSAIs and associated information. The UE context in SMF data comprises PDU session and EPC interworking information. The access and mobility subscription data, SMS selection subscription data, and/or UE context in SMF data indicates if UE 201 subscribed for secondary authentication with AAA server 227, static IP address assignment, and edge-based security service over SASE 231. For example, the SUPI of UE 201 may comprise a network specific identity code associated with enterprise network 241. AMF 221 forms the UE context for UE 201 using the retrieved information. The UE context defines the authorized services for UE 201.

In some examples, AMF 221 may transfer a policy creation request to a PCF (not illustrated) to create a policy association for UE 201. The PCF may respond to the request with policy association information like the SUPI, GPSI, PEI, and user location information for UE 201. The PCF may subscribe to AMF 221 for event reporting like user location updates, registration state changes, communication failure events, and the like. AMF 221 may create a PCF subscription based on the policy association information and signal to the PCF of the successful subscription creation.

Management portal 250 provides available IP segments to UE 201 based on a pool of available static IP addresses for devices associated with enterprise network 241. Management portal 250 further selects an IP segment of the IP segments and communicates the selection to the AAA server 227. AMF 221 selects one or more network slices for UE 201 based on the selected IP segment. Wireless network slices typically comprise collections core network and RAN resources that have capabilities to provide service types (e.g., low-latency service) to UEs. For example, AMF 221 may interface with an NSSF to select and assign a security slice for SASE user for UE 201. The assigned security slice may comprise UPF 223, portions of RAN 211, and/or other elements in network 200. This SASE security slice creates a dedicated virtual network segment for security services, enabling efficient data traffic management and routing for security purposes. With the security slice, users can access their data with enhanced security, efficiency, and seamless experience.

AMF 221 selects SMF 222 to serve UE 201 based on SMF selection data received from UDM 226 (and in some examples the network policies received from the PCF). AMF 221 transfers a list of requested PDU sessions with enterprise network 241 (as received during the registration request), a PDU session activation command, and the SUPI (that includes UE 201's IMSI) to SMF 222. AMF 221 indicates that UE 201 is subscribed for secondary authentication, static IP address assignment, and service over SASE 231.

SMF 222 receives the PDU session list, session activation command, and the SUPI from AMF 221. SMF 222 selects UPF 223 to support the PDU sessions based on the received data. SMF 222 initiates secondary authentication with AAA server 227 and static IP address assignment based on the indication from AMF 221 and/or management portal 250. AAA server 227 is representative of a network entity associated with enterprise network 241 to authenticate and authorize PDU sessions with enterprise network 241. Although illustrated as being located in 5G network core 220, in some examples AAA server 227 may instead be located in enterprise network 241. When located in network 241, SMF 222 and management portal 250 may communicate with AAA server 227 over UPF 223 and an AAA server proxy. When located in core network 220 (as illustrated in FIG. 2), SMF 222 and management portal 250 may communicate with AAA server 227 directly. AAA server 227 operates similarly whether located in core network 220 or enterprise network 241.

SMF 222 transfers a secondary authentication request to AAA server 227. The request indicates the IMSI of and requests static IP address assignment for UE 201. AAA server 227 receives the request and interfaces with address pool 228 to authenticate/authorize the PDU session for UE 201. Address pool 228 maintains a registry that associates IMSIs for devices associated with enterprise network 241 with MSISDNs, associates MSISDNs with assigned static IP addresses, and maintains a pool of available static IP addresses for devices associated with enterprise network 241. AAA server 227 correlates the IMSI with one of the MSISDNs to authenticate and authorize UE 201 for a PDU session with enterprise network 241. Based on the selected IP segment, AAA server 227 assigns static IP address for UE 201 from the pool of available static IP addresses responsive to the correlation of UE 201's IMSI with an MSISDN associated with enterprise network 241. AAA server 227 creates a binding between the selected static IP address, the IMSI of UE 201, and the MSISDN of UE 201 and stores the binding on address pool 228. AAA server 227 transfers an authorization message for UE 201's PDU session with enterprise network 241 to SMF 222. The authorization message comprises the static IP address, the MSISDN for UE 201, a PDU session authorization, and data like policy and charging information, list of allowed Media Access Control (MAC) addresses, list of allowed Virtual Local Area Network (VLAN) tags, authorized session Aggregate Maximum Bit Rate (AMBR), routing information, and the like.

SMF 222 receives the authorization message from AAA server 227. SMF 222 allocates the static IP addresses to UE 201 for the requested PDU sessions and allocates Tunnel End Point ID (TEID) for the session. SMF 222 transfers a session modification request that includes a session endpoint identifier, static IP address, MSISDN, session start/stop information, and TEID to UPF 223 to setup the default bearer for UE 201. The default bearer is a link to carry IP packets between UE 201 and enterprise network 241 over SASE 231. The default bearer traverses 5G RAN 211, UPF 223, SASE 231, and enterprise network 241. UPF 223 sets up a default bearer between UE 201, SASE 231, and enterprise network 241. UPF 223 transfers an accounting message to SASE 231 to enable edge-based security for UE 201. The accounting message includes the IMSI, MSISDN, session start data, session end data, and the like. SASE 231 receives the accounting message and selects security policies based on the received data. For example, SASE 231 may host a data structure that associates UE IMSIs with security policies, input UE 201's IMSI into the data structure, and select intrusion detection and prevention policies for the PDU session based on the output from the data structure.

SMF 222 notifies AMF 221 that the default bearer is set up. In response, AMF 221 registers UE 201 for service on network 200. AMF 221 generates a registration accept message that includes the allocated static IP addresses for UE 201, RAN IDs, AMBR, Globally Unique AMF ID (GUAMI), PDU session data, S-NSSAI list, security data, and the like. AMF 221 transfers the registration accept message to UE 201 over the NAS link that traverses RAN 211. UE 201 receives the registration accept message and launches a user application to begin the PDU session(s) with enterprise network 241. The application generates uplink data and UE 201 wirelessly transfers the uplink data for the PDU session to UPF 223 over the default bearer that traverses RAN 211. UPF 223 routes the uplink data to SASE 231. SASE 231 receives the uplink data and enforces the selected security policies on the uplink data. For example, SASE 231 may perform content filtering, session security, malware scanning, contents filtering, DNS filtering, firewall, intrusion detection and prevention, and the like on the PDU session. SASE 231 forwards the uplink data after enforcement of the security policies to enterprise network 241. Enterprise network 241 generates and transfers downlink data for the PDU session to SASE 231 based on the static IP address (or another identifier like MSISDN) for UE 201. SASE 231 enforces the security policies on the downlink data and forwards the secure downlink data to UPF 223. UPF 223 routes the downlink data to UE 201 over the default bearer that traverses RAN 211 based on the static IP address. In some examples, UPF 223 and SASE 231 may route the uplink/downlink traffic for specific applications executing on UE 201. Management portal 250 provides confirmation comprising details of the IP segment and secure connection to the user. Management portal 250 may further provide tools for monitoring IP usage and connectivity status and/or enable users and administrations to manage assignments, resolve conflict, and/or release the IP segment.

Similar to UE 201, non-3GPP UE 202 attaches to non-3GPP access node 214. For example, non-3GPP UE 202 may comprise a Wi-Fi only IoT device associated with enterprise network 241. Access node 214 provides non-3GPP wireless and/or wireline links like Wi-Fi, Ethernet, and Bluetooth. UE 202 transfers a registration request to AMF 221 over access node 214 and N3IWF 224. AMF 221, AUSF 225, and UDM 226 authenticate and authorize UE 202 for service similarly to the process described above for UE 201. SMF 222 interfaces with AAA server 227 to authenticate and authorize UE 202's PDU session with enterprise network 241 and select a static IP address for UE 202 similarly to the process described above for UE 201. SMF 222 allocates the selected static IP address for UE 202 and directs UPF 223 to serve UE 202. UPF 223 transfers an accounting message that includes the static IP address, MSISDN, session start/stop times, and the like to SASE 231 to enable edge security service for UE 202's PDU session. SMF 222 notifies AMF 221 that the session is ready to begin. AMF 221 transfers a registration accept message that includes the static IP address and other data for UE 202 to use to begin the PDU session to UE 202 over N3IWF 224 and access node 214. UE 202 begins the PDU session and exchanges data with UPF 223 over access node 214 and N3IWF 424. UPF 223 exchanges the data with SASE 231. SASE 231 enforces security policies on the data and exchanges the data with enterprise network 241.

In practice, users may register for a static IP via the management portal. The system verifies user eligibility and initiates the assignment process and appropriate billing. Next, the management portal displays available IP segments from the /8 pool. Segments may be dynamically divided into /12 to /24 subnets for assignment. In various aspect, the system or the user selects an available /12 to /24 segment and it is assigned to the user. Updates may be reflected by the management portal in real-time across all integrated systems. As the system is integrated with a SASE vendor, secure connectivity is provided for the user. The user may receive confirmation and details of their static IP and secure connection. Moreover, the management portal provides tools for monitoring IP usage and connectivity status which enables users and administrators to manage assignments, resolve conflicts, and release segments as needed.

For example, a user may request a static IP address to remotely manage devices, such as cameras, monitoring equipment, and other IoT devices. In another example, a user may request a static IP address to host a server, such as a web server, email server, or database server, to provide a stable and reliable IP address for connectivity. In another example, some applications, such as virtual private networks (VPNs) and voice over IP (VoIP) services, may require a static IP address to function properly. In another example, a user may request a static IP address to secure transactions, such as credit card payments, by providing a fixed and known address for communication. In another example, connected cars can use static IP addresses for autonomous driving and traffic status updates. In another example, security firms can use static IP addresses to secure buildings and remotely monitor security systems. In another example, health services can use static IP addresses for mobile health centers and ambulances to provide reliable and secure communication. In another example, schools can use static IP addresses for tablets and other connected devices to provide stable and reliable connectivity for students and teachers.

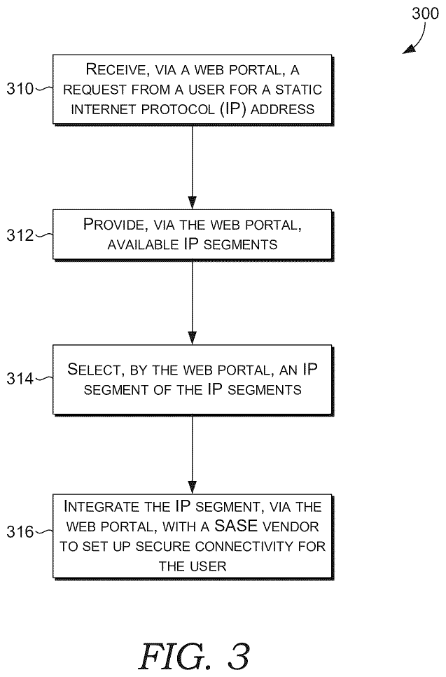

Referring now to FIG. 3, an example flowchart depicts a method of providing secure access service edge (SASE) static internet protocol (IP) management portal, in accordance with aspects of the present invention. Method 300 may be performed by any computing device (such as computing device described with respect to FIG. 4) or components of communication network (such as the communication network described with respect to FIG. 1 or 2). Initially, at step 310, a request from a user for a static internet protocol (IP) address is received via a management portal.

At step 312, available IP segments are provided via the management portal. In some aspects, the IP segments are from a /8 pool. The IP segments may be dynamically divided from the /8 pool into /12 to /24 subnets for assignment. The available IP segments provided via the management portal may be updated in real-time. In this way, conflicts (i.e., more than one user selecting the same IP segment) are avoided. At step 314, an IP segment of the IP segment is selected by the management portal.

At step 316, the IP segment is integrated, via the management portal, with a SASE vendor to set up secure connectivity for the user. The IP segment of the IP segments is assigned to the user. Moreover, confirmation comprising details of the IP segment and secure connection is provided to the user.

Additionally, the management portal may provide tools for monitoring IP usage and connectivity status. Further, the management portal may enable users and administrations to manage assignments, resolve conflicts, and/or release the IP segment.

Having described the example embodiments discussed above of the presently disclosed technology, an example operating environment of an example user device is described below with respect to FIG. 4. User device 400 is but one example of a suitable computing environment, and is not intended to suggest any particular limitation as to the scope of use or functionality of the technology disclosed. Neither should user device 400 be interpreted as having any dependency or requirement relating to any particular component illustrated, or a particular combination of the components illustrated in FIG. 4.

As illustrated in FIG. 4, example user device 400 includes a bus 402 that directly or indirectly couples the following devices: memory 404, one or more processors 406, one or more presentation components 408, one or more input/output (I/O) ports 410, one or more I/O components 412, a power supply 422, and one or more radios 424.

Example user device 400 may be configured to wirelessly communicate (e.g., by transmitting or receiving one or more signals) with one or more of the antenna elements of FIG. 1 or FIG. 1, other types of wireless telecommunication devices (e.g., other user devices, network nodes), or one or more combinations thereof. In embodiments, the user device 400 may include one or more of a unit, a station, a terminal, or a client, for example. In some embodiments, the user device 400 may act as a relay. In some embodiments, the user device 400 may be a wireless local loop station, an IoT device, an Internet of Everything device, a machine type communication device, an evolved or enhanced machine type communication device, another type of user device, or one or more combinations thereof.

Bus 402 represents what may be one or more busses (such as an address bus, data bus, or combination thereof). Although the various blocks of FIG. 4 are shown with lines for the sake of clarity, in reality, these blocks represent logical, not necessarily actual, components. For example, one may consider a presentation component, such as a display device, to be an I/O component. Also, processors have memory. Accordingly, FIG. 4 is merely illustrative of an exemplary user device that can be used in connection with one or more embodiments of the technology disclosed herein.

User device 400 can include a variety of computer-readable media. Computer-readable media can be any available media that can be accessed by user device 400 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 400. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 404 includes computer storage media in the form of volatile and/or nonvolatile memory. The memory 404 may be removable, non-removable, or a combination thereof. Example hardware devices of memory 404 may include solid-state memory, hard drives, optical-disc drives, other hardware, or one or more combinations thereof. As indicated above, the computer storage media of the memory 404 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 400, or one or more combinations thereof.

The one or more processors 406 of user device 400 can read data from various entities, such as the memory 404 or the I/O component(s) 412. The one or more processors 406 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 406 can execute instructions, for example, of an operating system of the user device 400 or of one or more suitable applications.

The one or more presentation components 408 can present data indications via user device 400, another user device, or a combination thereof. Example presentation components 408 may include a display device, speaker, printing component, vibrating component, another type of presentation component, or one or more combinations thereof. In some embodiments, the one or more presentation components 408 may comprise one or more applications or services on a user device, across a plurality of user devices, or in the cloud. The one or more presentation components 408 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof.

The one or more I/O ports 410 allow user device 400 to be logically coupled to other devices, including the one or more I/O components 412, some of which may be built in. Example I/O components 412 can include a microphone, joystick, game pad, satellite dish, scanner, printer, wireless device, and the like. The one or more I/O components 412 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 408 on the user device 400. In some embodiments, the user device 400 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 400 may, additionally or alternatively, be equipped with accelerometers or gyroscopes that enable detection of motion. In some embodiments, the output of the accelerometers or gyroscopes may be provided to the one or more presentation components 408 of the user device 400 to render immersive augmented reality or virtual reality.

The power supply 422 of user device 400 may be implemented as one or more batteries or another power source for providing power to components of the user device 400. In embodiments, the power supply 422 can include an external power supply, such as an AC adapter or a powered docking cradle that supplements or recharges the one or more batteries. In aspects, the external power supply can override one or more batteries or another type of power source located within the user device 400.

Some embodiments of user device 400 may include one or more radios 424 (or similar wireless communication components). The one or more radios 424 can transmit, receive, or both transmit and receive signals for wireless communications. In embodiments, the user device 400 may be a wireless terminal adapted to receive communications and media over various wireless networks. User device 400 may communicate using the one or more radios 424 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 424 may facilitate communication via radio frequency signals, frames, blocks, transmission streams, packets, messages, data items, data, another type of wireless communication, or one or more combinations thereof. The one or more radios 424 may be capable of transmitting, receiving, or both transmitting and receiving wireless communications via mm waves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. One or more computer-readable media having computer-executable instructions embodied thereon that, when executed, perform a method of providing secure access service edge (SASE) static internet protocol (IP) management portal, the method comprising:
receiving, via a management portal, a request from a user for a static IP address;
providing, via the management portal, available IP segments;
selecting, by the management portal, an IP segment of the IP segments;
integrating the IP segment, via the management portal, with a SASE vendor to set up secure connectivity for the user.

2. The media of claim 1, further comprising updating the available IP segments in real-time.

3. The media of claim 1, wherein the IP segments are from a /8 pool.

4. The media of claim 3, further comprising dynamically dividing the IP segments from the /8 pool into /12 to /24 subnets for assignment.

5. The media of claim 1, further comprising assigning the IP segment of the IP segments to the user.

6. The media of claim 5, further comprising providing confirmation to the user, the confirmation comprising details of the IP segment and secure connection.

7. The media of claim 1, wherein the management portal provides tools for monitoring IP usage and connectivity status.

8. The media of claim 1, wherein the management portal enables users and administrations to manage assignments, resolve conflicts, and/or release the IP segment.

9. A method for providing secure access service edge (SASE) static internet protocol (IP) management portal, the method comprising:
receiving, via a management portal, a request from a user for a static IP address;
providing, via the management portal, available IP segments;
selecting, by the management portal, an IP segment of the IP segments;
integrating the IP segment, via the management portal, with a SASE vendor to set up secure connectivity for the user.

10. The method of claim 9, further comprising updating the available IP segments in real-time.

11. The method of claim 9, wherein the IP segments are from a /8 pool.

12. The method of claim 11, further comprising dynamically dividing the IP segments from the /8 pool into /12 to /24 subnets for assignment.

13. The method of claim 9, further comprising assigning the IP segment of the IP segments to the user.

14. The method of claim 13, further comprising providing confirmation to the user, the confirmation comprising details of the IP segment and secure connection.

15. The method of claim 9, wherein the management portal provides tools for monitoring IP usage and connectivity status.

16. The method of claim 9, wherein the management portal enables users and administrations to manage assignments, resolve conflicts, and/or release the IP segment.

17. A system for providing secure access service edge (SASE) static internet protocol (IP) management portal, the system comprising:
a node configured to wirelessly communicate with user equipment (UE); and
the UE configured to:
enable a user to submit, via a management portal, a request for a static IP address;
enable the user to visualize, via the management portal, available IP segments; and
enable the user to select, via the management portal, an IP segment of the IP segments.

18. The system of claim 17, further comprising enabling the user to receive, via the management portal, a confirmation comprising details of the IP segment and secure connection.

19. The system of claim 17, further comprising enabling the user monitor IP usage and connectivity status.

20. The system of claim 17, further comprising enabling users and administrations, via the management portal, to manage assignments, resolve conflicts, and/or release the IP segment.
